(19) United States
(12) Patent Application Publication
(10) Pub. No.: US 2026/0246989 A1
(43) Pub. Date: Aug. 20, 2026

(54) METHOD, APPARATUS, DEVICE, AND STORAGE MEDIUM FOR INFORMATION PRESENTATION

(71) Applicant: BYTEDANCE TECHNOLOGY LTD., Grand Cayman (KY)

(72) Inventors: Xiu Pei, Beijing (CN); Xin Li, Beijing (CN)

(21) Appl. No.: 19/543,803

(22) Filed: Feb. 18, 2026

(30) Foreign Application Priority Data
Feb. 20, 2025 (WO) PCT/SG2025/050117

(51) Int. Cl. H04N 21/25

(52) U.S. Cl. CPC H04N 21/251

(57) ABSTRACT

Embodiment of the disclosure relates to a method, apparatus, device and storage medium for information presentation. The method includes: presenting a first playing interface of a first media content, the first media content being associated with a music content; presenting a detail interface of the music content in response to receiving a first operation on the first playing interface, the detail interface presenting a first set of media contents associated with the music content; and presenting a second set of media contents on the detail interface in response to a quantity of media contents in the first set of media contents being less than or equal to a preset quantity, wherein at least part of the second set of media contents is determined based on the first media content. In this way, the embodiments of the disclosure may improve and enrich the media content presented in the detail interface.

### CROSS-REFERENCE

This application claims priority to Internation Application No. PCT/SG2025/050117 , filed on February 20, 2025, and entitled “METHOD, APPARATUS, DEVICE, AND STORAGE MEDIUM FOR INFORMATION PRESENTATION”, which is incorporated herein by reference in its entirety.

### FIELD

Example embodiments of the present disclosure generally relate to the field of computers, and in particular, to a method, apparatus, device, and computer-readable storage medium for information presentation.

### BACKGROUND

With the continuous development of Internet technologies, users may browse various media contents through the Internet. In the related art, the music content associated with the media content may be viewed, for example, other media contents associated with the music content.

### SUMMARY

In a first aspect of the present disclosure, a method for information presentation is provided. The method includes: presenting a first playing interface of a first media content, the first media content being associated with a music content; presenting a detail interface of the music content in response to receiving a first operation on the first playing interface, the detail interface presenting a first set of media contents associated with the music content; and presenting a second set of media contents on the detail interface in response to a quantity of media contents in the first set of media contents being less than or equal to a preset quantity, wherein at least part of the second set of media contents is determined based on the first media content.

In a second aspect of the present disclosure, an apparatus for information presentation is provided. The apparatus includes a first playing module, a first rendering module and a second rendering module. The first playing module is configured to present a first playing interface of a first media content, the first media content being associated with a music content; the first rendering module is configured to present a detail interface of the music content in response to receiving a first operation on the first playing interface, the detail interface presenting a first set of media contents associated with the music content; and the second rendering module is configured to present a second set of media contents on the detail interface in response to a quantity of media contents in the first set of media contents being less than or equal to a preset quantity, wherein at least part of the second set of media contents is determined based on the first media content.

In a third aspect of the present disclosure, an electronic device is provided. The device includes at least one processor; and at least one memory coupled to the at least one processor and storing instructions for execution by the at least one processor, the instructions, when executed by the at least one processor, causing the electronic device to perform the method the first aspect.

In a fourth aspect of the present disclosure, a computer-readable storage medium is provided. The computer-readable storage medium has a computer program stored thereon, the computer program being executable by a processor to implement the method of the first aspect.

It would be appreciated that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the present disclosure may be implemented;

FIGS. 2A-2F illustrate example interfaces according to some embodiments of the present disclosure;

FIG. 3 illustrates a flowchart of an example process of a method for information presentation according to some embodiments of the present disclosure;

FIG. 4 illustrates a schematic structural block diagram of an example apparatus of an apparatus for information presentation according to some embodiments of the present disclosure; and

FIG. 5 illustrates a block diagram of an electronic device capable of implementing various embodiments of the present disclosure.

### DETAILED DESCRIPTION

Embodiments of the present disclosure would be described in more detail below with reference to the accompanying drawings. While certain embodiments of the present disclosure are illustrated in the accompanying drawings, it would be appreciated that the present disclosure may be implemented in various forms and would not be construed as limited to the embodiments set forth herein. Rather, these embodiments are provided for a more thorough and complete understanding of the present disclosure. It would be appreciated that the drawings and embodiments of the present disclosure are for example purposes only and are not intended to limit the scope of the present disclosure.

It would be appreciated that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms ‘including’ and the like would be understood to include ‘including but not limited to’. The term ‘based on’ would be understood as ‘based at least in part on’. The terms ‘one embodiment’ or ‘the embodiment’ would be understood as ‘at least one embodiment’. The term ‘some embodiments’ would be understood as ‘at least some embodiments’. Other explicit and implicit definitions may also be included below. The terms ‘first,’ ‘second,’ and the like may refer to different or identical objects. Other explicit and implicit definitions may also be included below.

Embodiments of the present disclosure may relate to data of a user, obtaining and/or use of data, and the like. These aspects all follow the corresponding laws and regulations and related regulations. In the embodiments of the present disclosure, all data collection, acquisition, processing, handling, processing, reposting, use, and the like are carried out on the premise of the knowledge and confirmation of the user. Accordingly, when implementing the embodiments of the present disclosure, the types of the data or information that may be involved, the usage scope, the usage scenario, and the like would be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function and may not affect the basic function of the user.

As mentioned above, with the continuous development of Internet technology, users can browse various types of media contents through the Internet, such as selection content of film and television works, video content with associated background music, and the like.

Taking the media content associated with the music content as an example, in the related art, the music content associated with the media content may be viewed as details, for example, description information such as a music name and an author of the music content, and then information such as other media contents using the music content may also be viewed.

However, in some scenarios, for example, for a period of time after some music contents are first post or first referenced on a certain media platform, for another example, for a period of time after some music contents are first associated with the media content, in a media content collection of the media platform, there is a low quantity of media contents associated with those music contents. In such a case, since less media content can be seen by the user by viewing the detail interface of the music content, the user is prone to produce a certain degree of negative impression on that music content, which affects the user's perception, and even affects the work conversion rate of the music content.

The embodiment of the present disclosure provides an information presentation scheme. The scheme includes: presenting a first playing interface of a first media content, the first media content being associated with a music content; presenting a detail interface of the music content in response to receiving a first operation on the first playing interface, the detail interface presenting a first set of media contents associated with the music content; and presenting a second set of media contents on the detail interface in response to a quantity of media contents in the first set of media contents being less than or equal to a preset quantity, wherein at least part of the second set of media contents is determined based on the first media content.

In this way, the embodiments of the present disclosure can effectively enrich media contents presented on a detail interface of music contents.

Various example implementations of this scheme are described in detail below in conjunction with the accompanying drawings.

### Example Environment

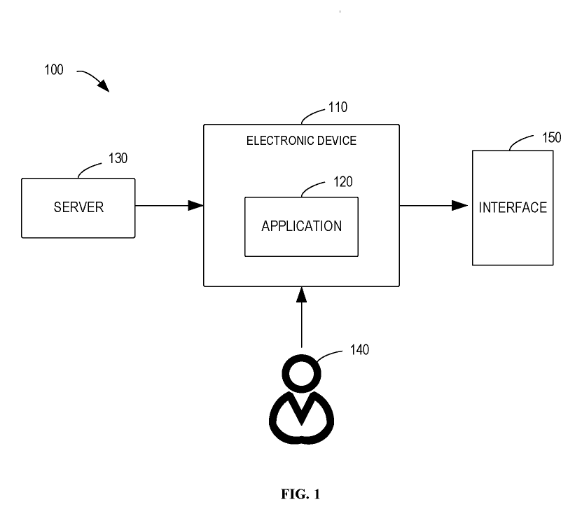

FIG. 1 illustrates a schematic diagram of an example environment 100 in which embodiments of the present disclosure may be implemented. As illustrated in FIG. 1, the example environment 100 may include an electronic device 110.

In this example environment 100, the electronic device 110 may run an application 120 that supports information presentation. The application 120 may be any suitable type of application for information presentation, examples of which may include, but are not limited to: multimedia interaction, audio playing, video playing, or other suitable application. The user 140 may interact with the application 120 via the electronic device 110 and/or its attachment device.

In the environment 100 of FIG. 1, if the application 120 is in an active state, the electronic device 110 may present, via the application 120, an interface 150 for supporting information presentation.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be a standalone physical server, or may be a server cluster or a distributed system composed of a plurality of physical servers, or may be a cloud server that provides basic cloud computing services such as cloud services, cloud databases, cloud computing, cloud functions, cloud storage, network services, cloud communications, middleware services, domain name services, security services, content distribution networks, big data and artificial intelligence platforms. The server 130 may include, for example, a computing system/server, such as a mainframe, an edge computing node, a computing device in a cloud environment, or the like. The server 130 may provide background services for applications 120 that support information presentation in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (Wi-Fi) connection, and the like, and the embodiments of the present disclosure are not limited in this aspect. In an embodiment of the present disclosure, the server 130 and the electronic device 110 may implement signaling interaction through a communication connection therebetween.

It would be appreciated that the structures and functions of the various elements in the environment 100 are described for example purposes only and do not imply any limitation to the scope of the present disclosure.

Some example embodiments of the present disclosure will be described below with continued reference to the accompanying drawings.

### Example Interaction

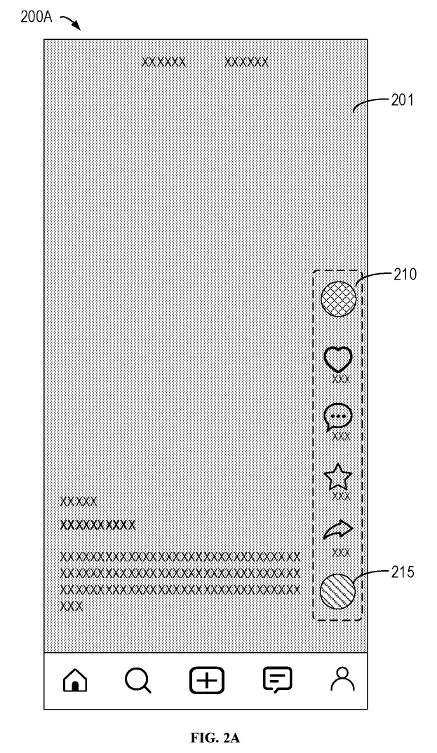

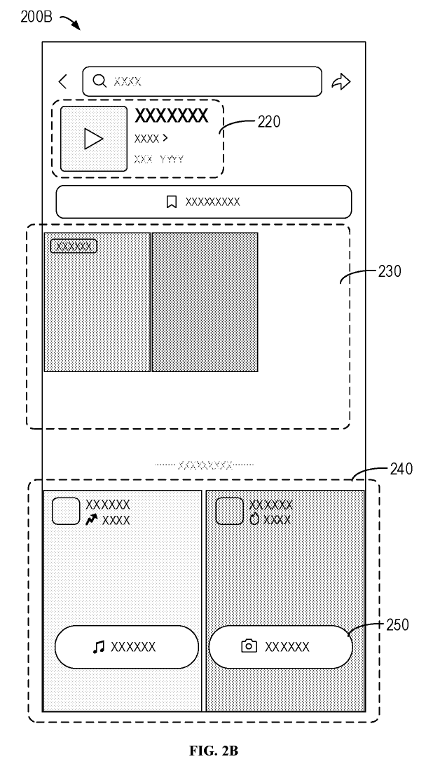

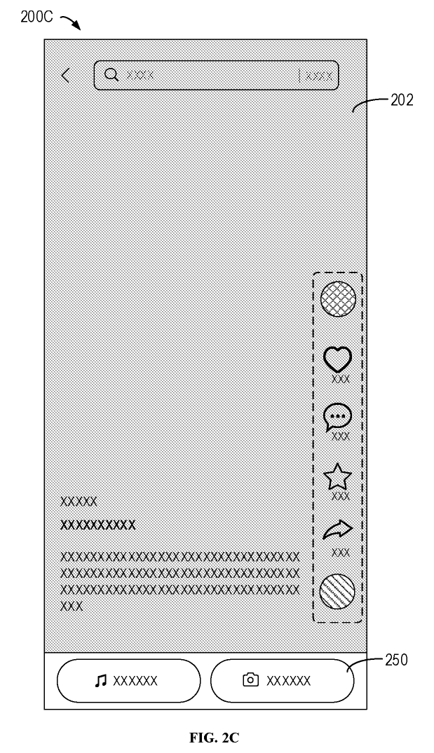

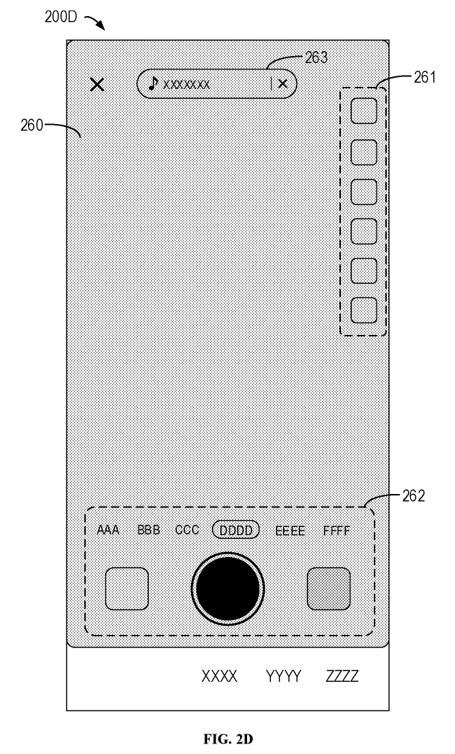

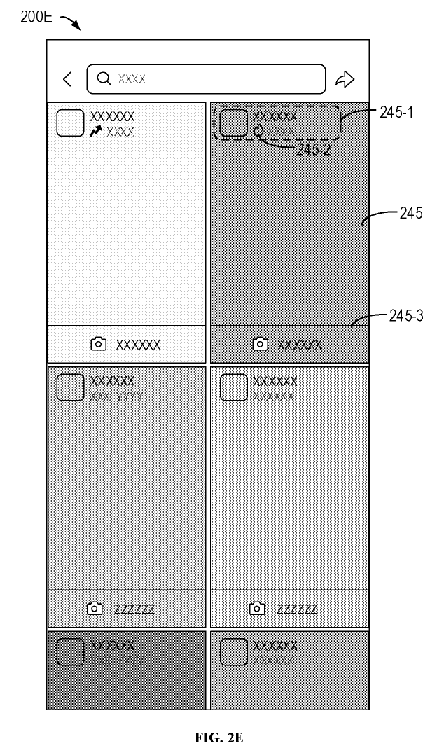

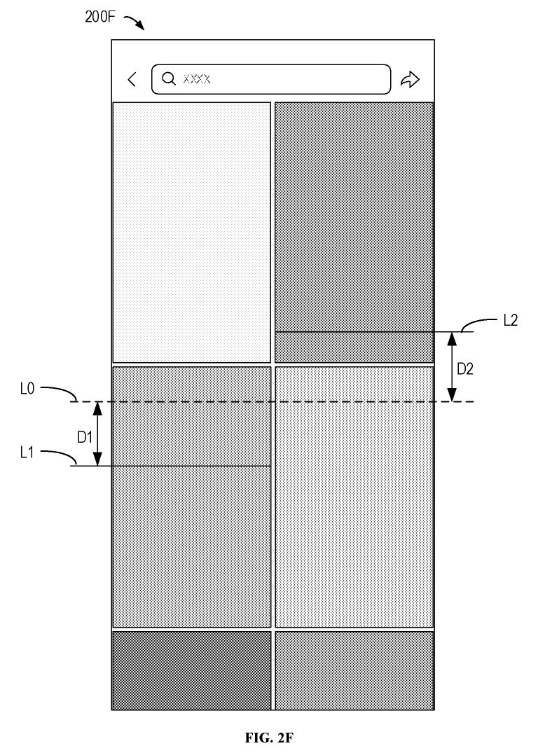

FIGS. 2A-2E illustrate example interfaces 200A-200F according to some embodiments of the present disclosure. The interface 200A to the interface 200F may be provided, for example, by the electronic device 110 illustrated in FIG. 1.

Referring to FIG. 2A, FIG. 2A illustrates the example playing interface 200A according to some embodiments of the present disclosure. For example, the electronic device 110 may present the playing interface 200A based on a response to an operation of the installed application 120, or based on a response to at least one item of the application 120.

As an example, the playing interface 200A may correspond to a media content 201 for frame-by-frame presentation of the media content 201. For example, the video frames associated with a predetermined speed may be presented frame-by-frame at a predetermined speed (e.g., ×1,×0.5, ×2, etc.).

In some embodiments, the playing interface 200A may be an initial playing interface presented by the application 120 illustrated in FIG. 1, or may be a playing interface presented after any media content in the application 120 is further operated, which is not limited herein.

In some implementations, description information of the media content 201, such as title information, tag information, summary information, etc., of the media content 201 may be presented at the bottom of the playing interface 200A.

As illustrated in FIG. 2A, the playing interface 200A includes an operation panel 210, the operation panel 210 includes at least one operation control, for example, an operation control for following/unfollowing an author of the media content 201. For a further example, an operation control such as a liking control, a commenting control, a collecting control, and a sharing control for the content presented in the media content 201. . For a further example, an operation control such as a music content, an effect template, a description template and the like associated or applied in the media content 201.

In some embodiments, via any of the operation panels 210, a corresponding operation of the user may be received and responded to. As an example, a first operation for a music content associated with the media content 201 may be received via an operation control 215 as illustrated in FIG. 2A. In response to the first operation, the electronic device 110 may present a detail interface of the music content, for example, a detail interface 200B illustrated in FIG. 2B.

FIG. 2B illustrates the example detail interface 200B according to some embodiments of the present disclosure. Referring to FIG. 2B, the detail interface 200B includes a detail panel 220 of the music content. As an example, at least one piece of information such as a music cover, a music name, author information, and interaction information of the music content may be presented in the detail panel 220. Herein, the music cover may be any associated image such as an author image of the music content and an album cover to which the music content belongs, which is not limited herein. The author information may include the author name. The interaction information may be at least one of a collection quantity of the music content, an associated reference quantity, and the like, which is not limited herein.

In some embodiments, the author information may not only be presented as one piece of the associated information of the music content, but also may be presented as a trigger entry, for example, via the trigger of the author information, the author information may be entered into a music list interface post by the author to view other music contents post by the same author.

As illustrated in FIG. 2B, the detail interface 200B may also present a first set of media contents 230 associated with the music content. As an example, the first set of media contents 230 may include a part or all of the media content that references or associates the musical content. For example, the first set of media contents 230 may be all media contents associated with the music content in a media database or a media content collection of the application 120.

For example, taking the music content as the at least part of the music segment of the music work as an example, the first set of media contents 230 includes all media contents that reference the music segment in an online database of the application 120, for example, taking the music segment as at least a part of background music of the media content.

In some embodiments, the first set of media contents 230 may be presented on the detail interface 200B in the form of a waterfall stream. For example, the first set of media contents 230 may be presented in the form of a fixed or interleaved waterfall stream. As an example, the first set of media contents 230 is presented in FIG. 2B with a fixed waterfall stream of three columns of distributions. In other implementations, the first set of media contents may also be presented by using a waterfall stream distributed in two columns or four columns, which is not limited herein.

In some embodiments, the first set of media contents 230 fails to fully present on the current page, sliding the page to present, e.g., sliding up the current page.

In some embodiments, for example, in a scenario in which the quantity of the first set of media contents 230 is small (for example, less than or equal to 10 or 15 preset quantity), the detail interface 200B may also present a second set of media contents 240. The at least one media content of the second set of media contents 240 is determined based on the media content played in the playing interface 200A.

In this solution, the second set of media contents 240 may be determined as a supplement or extension to the first set of media contents 230, the media content on the detail interface 200B may be effectively enriched, more associated media content is provided for the user, the user experience is improved, and the work conversion rate of the media content may be improved to a certain extent.

It would be appreciated that, in this solution, any media content of the second set of media contents 240 does not use the music content described by the detail panel 220.

In some embodiments, the second set of media contents 240 is determined based on at least one of: first reference information associated with the media content 201, for example, a text content, an effect, a template, an author, and the like of the media content 201; second reference information associated with the music content described by the detail panel 220, for example, information such as a work style, an author, an album, and the like of the music content; third reference information associated with the current user, for example, historical collection records of the current user, historical comment records, historical like records, and other historical interaction information and interaction rate information such as a collected rate of media content related to the historical interaction information; fourth reference information of the media content of the second set of media contents 240, for example, text content information, like or comments or viewing, etc., of the selected media content, a quantity of works that reference the media content for editing and creation, and the like.

In this way, determining manner and basis of the second set of media contents 240 may be fully extended, so that the association between the second set of media contents 240 and the media content played in the playing interface 200A may be ensured, and the richness of the media content of the second set of media contents 240 may be improved.

In some embodiments, the second set of media contents 240 may be determined from a historical collection record of the user, a historical like record, or a waiting candidate media content collection of the media content database of the platform.

In this way, the second set of media contents 240 may be quickly determined from the historical interaction record of the user, and the determination efficiency of the second set of media contents 240 may be improved; based on the media content database of the platform, the second set of media contents 240 may be fully enriched, thereby ensuring the quantity of media content of the second set of media contents 240.

In some embodiments, in the process of determining the second set of media contents 240, it is necessary to filter out the media content that is not suitable for recommendation based on a predetermined filtering condition. For example, the predetermined filtering condition includes, but is not limited to: a media content relates to music propaganda activities, a media content may not be recommended due to reasons such as network ecological problems or configurations that are only visible to themselves, and the like, and a media content involves superstitious or wishing-related content.

In this way, the media content that does not satisfy the recommendation rule may be quickly filtered out, thereby improving the determination efficiency and the presentation efficiency of the second set of media contents 240.

In some embodiments, the second set of media contents 240 may be presented in the same area of the detail interface 200B as the first set of media contents 230, or may be presented in different areas.

In the embodiment illustrated in FIG. 2B, the second set of media contents 240 and the first set of media contents 230 are distributed in different areas of the detail interface 200B, and the presentation area of the second set of media contents 240 and the presentation area of the first set of media contents 230 are configured with a predetermined spacing. In this way, the user may conveniently distinguish the first set of media contents 230 and the second set of media contents 240, thereby improving the user experience.

In some embodiments, the predetermined spacing may be associated with a distance between a presentation boundary of the first set of media contents 230 and an initial page boundary of the detail interface 200B, or may be associated with a presentation cover specification of the media content of the first set of media contents 230. For example, the predetermined spacing may be a fixed value, or may be a variation value determined based on a predetermined rule algorithm, which is not limited herein.

In some implementations, the second set of media contents 240 may be presented on the detail interface 200B in the form of a fixed or interleaved waterfall stream. As illustrated in FIG. 2B, the second set of media contents 240 is presented on the detail interface 200B in a dual-column-fixed waterfall stream. In some other embodiments, the second set of media contents 240 may also be presented in a single-column or a three-column distributed waterfall stream, which is not limited herein.

In some embodiments, the second set of media contents 240 may also be presented in the same area of the detail interface 200B as the first set of media contents 230. For example, the second set of media contents 240 may be presented sequentially or mixed with the first set of media contents 230. In this way, the presentation rate of the second set of media contents 240 is provided, and the work conversion rate of the media content of the second set of media contents 240 may be further improved.

In some embodiments, the user may enter an independent playing interface of the media content by triggering any media content of the first set of media contents 230 or the second set of media contents 240 within the detail interface 200B to play the triggered media content separately, such as a playing interface 200C illustrated in FIG. 2C. In this way, the playing effect of the media content may be improved, and the user experience may be improved.

Referring to FIG. 2C, a media content 202 played in the playing interface 200C is any media content of the first set of media contents 230 or the second set of media contents 240 triggered on the detail interface 200B.

In some embodiments, in the playing interface 200C, the user may switch the media contents presented in the playing interface 200C through a switching operation. For example, the media content 202 presented by the playing interface 200C may be switched by a sliding operation in any direction such as upward, downward, leftward, rightward, or the like. For example, one media content of the first set of media contents 230 is switched to a further media content of the first set of media contents 230, or is switched to one media content of the second set of media contents 240; for a further example, one media content of the second set of media contents 240 is switched to a further media content of the second set of media contents 240, or is switched to one media content of the first set of media contents 230.

In this way, the media content of the first set of media contents 230 and/or the second set of media contents 240 can be played in sequence, the inconvenience brought by playing again after the detail interface 200B needs to be returned is avoided, and the user experience is improved.

As illustrated in FIG. 2C, the playing interface 200C includes a first editing entry 250, and based on the trigger of the editing entry 250, a corresponding media editing interface can be entered, for example, an editing interface 200D illustrated in FIG. 2D. For example, within the entered media editing interface, the content associated with the currently played media content 202 in the playing interface 200C may be edited to generate new media content.

In this way, the editing efficiency of the media content may be improved, and the work conversion rate of the media content played in the playing interface 200C may be improved.

In some embodiments, within the media editing interface presented based on triggering the first editing entry 250, the editing may be performed based on at least one of : a text content, a music content, an effect, a media template, etc. associated with the media content 202 to generate a new media content. In this way, the content type associated with the new media content may be enriched, the work conversion rate of the content associated with the media content 202 may be sufficiently improved, and the work conversion rate of the media content 202 may be improved.

Referring to FIG. 2D, in the editing interface 200D, a display panel 260 is included, and a control panel 261 and an option panel 262 are provided in the display panel 260. Herein, the control panel 261 includes at least one editing control for generating media contents, and the option panel 262 includes at least one editing option for generating media contents.

In some embodiments, the editing control in the control panel 261 may include an operation control for the content associated in the media content 202 played in the playing interface 200C, or may include an operation control for an appliance (for example, a front camera or a rear camera, a flashlight, etc.) configured for the electronic device presenting the editing interface 200D, and may further include other editing controls for generating a media content, which is not limited herein.

In some embodiments, the editing options in the options panel 262 may include editing options for the associated content for generating the media content, such as at least one of: a type option (image or video) to generate a media content, a text option to generate a media content, a template option, an effect option, a music option, and the like.

In the editing interface 200D illustrated in FIG. 2D, the user may generate a new media content by operating at least one editing control in the control panel 261 and at least one option control in the operation option panel 262. Herein, the media content editing process generated in the user operation process and the finally generated new media content may be presented through the display panel 260.

In some example implementations, the generated new media content may be presented as one of the recommended media content, and presented in a detail interface of the music content associated with the media content 202, for example, as one item of the first set of media contents or the second set of media contents on the detail interface.

Referring back to FIG. 2B, the detail interface 200B further includes a second editing entry 270. For example, the second editing entry 270 represents an operation entry for media editing based on the music content described by the detail panel 220. That is, based on the trigger of the second editing entry 270, the media editing interface may be entered, and the creation or editing of the media content may be performed based on the music content described by the detail panel 220 within the media editing interface.

In this way, the music content described by the detail panel 220 may be quickly converted, the work conversion rate of the music content is improved, and the generation efficiency of the new media content is improved.

For example, the media editing interface presented based on the trigger of the second editing entry 270 may also refer to the media editing interface 200D illustrated in FIG. 2D.

It would be appreciated that, for the media editing interface presented based on the trigger of the second editing entry 270 and the media editing interface presented based on the trigger of the first editing entry 250, the interface schematic of the two editing interfaces may refer to the editing interface 200D illustrated in FIG. 2D. However, the media editing interfaces presented by the two editing interfaces are not the same, and at least one editing control in the control panel 261 corresponding to the two media editing interfaces is different.

The following continues with reference to the editing interface 200D illustrated in FIG. 2D, and describes the media editing interface presented by the trigger based on the second editing entry 270. In this scenario, the display panel 260 of the editing interface 200D may further provide a music configuration control 263, and may generate a new media content based on the music content provided by the music configuration control 263.

In the editing interface 200D presented based on the trigger of the second editing entry 270 in FIG. 2B, the music content provided by the music configuration control 263 may be a music content described by the detail panel 220 in FIG. 2B.

Referring back to FIG. 2B, in this solution, the second set of media contents 240 may not be completely presented in the home page of the detail interface 200B, and therefore, page turning is required to view the media content that fails to be presented in the home page. For example, the page turning may be implemented by a sliding operation on the detail interface 200B.

In some embodiments, the detail interface 200B is switched to a detail interface 200E illustrated in FIG. 2E by responding to an upward sliding operation on the detail interface 200B to view the media content of the second set of media contents 240 that fails to be presented on the detail interface 200B.

Referring to FIG. 2E, on the detail interface 200E, a media cover 245 corresponding to the media content of the second set of media contents 240 is presented, and the description information 245-1 associated with the media content is presented in the media cover 245.

Based on the description information 245-1 in the media cover 245, information corresponding to the media content may be intuitively and explicitly presented.

In some embodiments, the description information 245-1 may be used to indicate interaction information of the media content, for example, reference information such as an edit creation amount of the media content, an amount of play of the media content, a quantity of likes, an amount of collection, an amount of comment, and the like.

In some embodiments, the description information 245-1 may also be used to indicate a source of the media content, for example, a favorite list of the current user.

In some embodiments, the description information 245-1 may include, but is not limited to, at least one of: an author avatar of the media content, an author name, a name of the media content, and the like.

In some embodiments, the description information 245-1 may be configured as a trigger entry. Based on the trigger of the description information 245-1, an associated content detail interface of the media content described by the description information 245-1 may be presented, for example, an associated music content or an associated effect or a detail interface of an associated template.

In some embodiments, the description information 245-1 may further include a graphic element 245-2, for example, a graphic element that represents an increase in any interaction amount such as an amount of play, an amount of attention, an amount of comment, an amount of collection, and an amount of edit. For example, the graphic element 245-2 may be obtained from a predetermined image element set.

As illustrated in FIG. 2E, on the detail interface 200E, the media cover 245 further includes a third editing entry 245-3, which a media editing interface may be entered by triggering the third editing entry 245-3. Within the media editing interface, an edit can be performed to generate a new media content based on the content associated with the media content where the media cover 245 is located.

In this way, the user may quickly perform a media creation based on the content associated with the media content where the media cover 245 is located, thereby improving the efficiency of the media content generation; and improving the work conversion rate of the media content where the media cover 245 is located.

In some embodiments, within the media editing interface presented based on the third editing entry 245-3, editing may be performed based on at least one of text content, music content, effects, and media templates associated with the media content corresponding to the media cover 245 to which the third editing entry 245-3 belongs to generate new media content.

In some implementations, the display position of the second set of media contents 240 in the page displayed by the detail interface 200B or 200E may be moved based on the sliding operation received on the detail interface 200B or 200E.

In some implementations, a trigger line is configured in the display page of the detail interfaces 200B and 200E to serve as a trigger for whether the media content is played in the second set of media contents 240. When the display position of the second set of media contents 240 on the detail interface 200B or 200E changes, the corresponding trigger line is triggered as the display position of the media content moves, thereby playing the media content that triggers the trigger line.

In this way, the media content of the second set of media contents 240 may be adaptively or selectively played on the detail interface, thereby improving playing efficiency and user experience of the media content.

For example, corresponding to media contents distributed in different columns, the configured trigger line positions are different, so as to prevent media contents in different columns from being played simultaneously.

Taking the scenario in which the second set of media contents 240 is presented in the form of the double-row fixed waterfall stream illustrated in FIGS. 2B and 2E as an example, FIG. 2F illustrates an example location schematic interface 200F of the trigger line in the display page of the detail interface.

Referring to FIG. 2F, the left side of the display page of the display interface 200F is provided with a first trigger line L1, the right side of the display page is provided with a second trigger line L2, and the positions of the first trigger line L1 and the second trigger line L2 in the height direction of the display page are different.

In the scenario illustrated in FIG. 2F, the first trigger line L1 is disposed below the second trigger line L2 in the height direction of the display page. For example, the first trigger line L1 is lower than a middle bit line L0 of the display page, and the second trigger line L2 is higher than the middle bit line L0.

In some embodiments of such a scenario, during the upward movement of the second set of media contents 240 based on the sliding operation, the first trigger line L1 is triggered first, so that the left media content on the left side triggers the first trigger line L1 to play first. As the second set of media contents 240 moves up continuously, the media content located on the right triggers the second trigger line L2, at this time, the right media content of the second trigger line L2 is triggered to start playing, and the left media content in the previous play ceases playing. In this way, the first trigger line L1 and the second trigger line L2 are alternately triggered, and each media content therein may be played one by one with the movement of the second set of media contents 240. In this process, the user may pause the sliding operation, so that the second set of media contents 240 stays at the corresponding position to continuously play the corresponding left media content or the right media content to fully understand the content information presented by the media content.

Referring to FIG. 2F, in some embodiments, a first distance D1 between the first trigger line L1 and the middle bit line L0 and a second distance D2 between the second trigger line L2 and the middle bit line L0 may be the same or different.

In some embodiments, the first distance D1 and the second distance D2 may be fixed values, or may be variation values based on a predetermined calculation rule. For example, the first distance D1 or the second distance D2 may be associated with the page height of the display page, or may be associated with the height of the media content of the second set of media contents 240 on the detail interface, or may be associated with the height of the media cover 245, which is not limited herein.

In some other implementations, the position of the first trigger line L1 may also be higher than the second trigger line L2 configuration, which may be specifically illustrated in FIG. 2F for the opposite configuration, and details are not described herein again.

Referring back to FIG. 2B and FIG. 2E, in some embodiments of the present solution, in the process of moving the second set of media contents 240 based on the sliding operation, the second editing entry 270 may be ceased presenting.

For example, the second editing entry 270 may be ceased presenting in the process of moving the second set of media contents 240. That is, when the position of the first set of media contents 230 and the second set of media contents 240 on the detail interface remain unchanged, the second editing entry 270 is presented. Once the display position of the first set of media contents 230 and the second set of media contents 240 changes due to the movement operation, the second editing entry 270 is hidden.

In this way, the second editing entry 270 may be effectively prevented from blocking the media content in the display position change, thereby improving the user experience.

In some embodiments, when no media content is in the playing state in the second set of media contents, even if the display position of the second set of media contents 240 changes, the second editing entry 270 is still presented. In response to any media content of the second set of media contents 240 triggering the corresponding trigger line, the second editing entry 270 is ceased presenting, that is, the second editing entry 270 is hidden.

In this way, the second editing entry 270 is hidden only if there is a media content in the playing state, the second editing entry 270 may be prevented from blocking the media content in the playing, the presentation effect of the media content in the playing is ensured. When the media content is not in the playing state, the user may conveniently trigger the second editing entry 270 in time to quickly enter the corresponding media editing interface, thereby improving the user experience.

### Example Processes

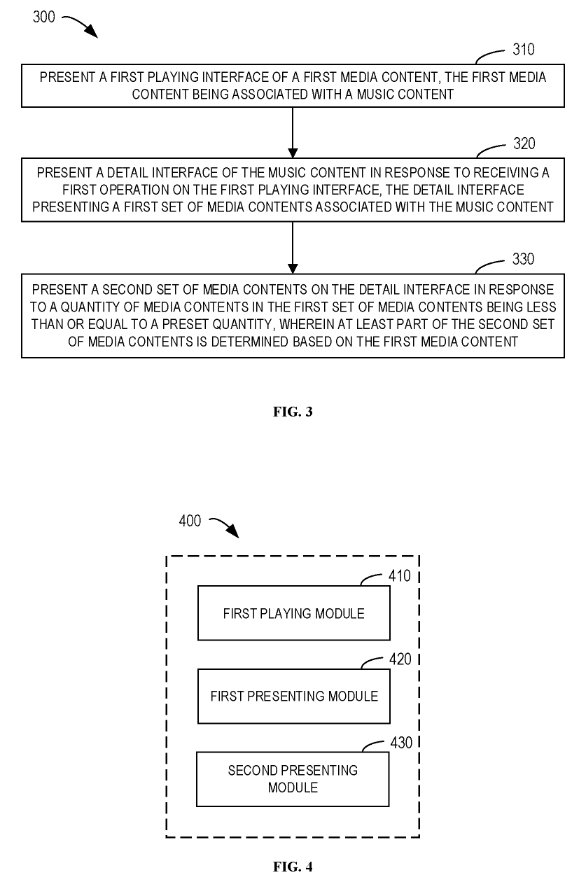

FIG. 3 illustrates a flowchart of an example process 300 of a method for information presentation according to some embodiments of the present disclosure. The process 300 may be implemented at the electronic device 110. The process 300 is described below with reference to FIG. 1.

As illustrated in FIG. 3, at block 310, the electronic device 110 presents a first playing interface of a first media content, the first media content being associated with a music content.

For example, the first media content may be a video content including a visual element and an audio element.

In this solution, the first playing interface includes a presentation area of the first media content, and may further include at least one operation control for the associated content of the first media content, for example, a viewing control or a referencing control of an effect associated with the first media content, a viewing control of the music content associated with the first media content, and the like.

As an example, referring to FIG. 2A, the first playing interface may be the playing interface 200A, the first media content may be the media content 201, and the operation control may be the operation control 215 in the operation panel 210.

In some implementations, the first playing interface further includes at least one interaction control, for example, a liking control, a commenting control, a collecting control, and a sharing control, and the like for the first media content, which is not limited herein. As an example, reference may be made to other controls other than the operation control 215 in the operation panel 210 illustrated in FIG. 2A.

Referring back to FIG. 3, at block 320, the electronic device 110 presents a a detail interface of the music content in response to receiving a first operation on the first playing interface, the detail interface presenting a first set of media contents associated with the music content.

As an example, referring to FIG. 2A, the first operation received on the first playing interface may be an operation received based on the operation control 215, for example, a trigger operation on the operation control 215.

In some embodiments, based on the detail interface presented by the first operation, reference may be made to the detail interface 200B illustrated in FIG. 2B as an example. The first set of media contents 230 associated with the music content associated with the media content 201 is presented on the detail interface 200B.

Referring back to FIG. 3, at block 330, the electronic device 110 presents a second set of media contents on the detail interface in response to a quantity of media contents in the first set of media contents being less than or equal to a preset quantity, wherein at least part of the second set of media contents is determined based on the first media content.

As an example, with continued reference to FIG. 2B, in response to a quantity of media contents of the first set of media contents 230 being less than or equal to a preset quantity, for example, the preset quantity may be any preset value such as 10 or 8, the second set of media contents 240 is presented on the detail interface 200B. Herein, at least part of the media content of the second set of media contents 240 is determined based on the media content 201 played in the playing interface 200A.

In this solution, when the quantity of media contents of the first set of media contents is insufficient, the first set of media contents is presented on the detail interface of the music content, and at least part of the media content is also presented as the second set of media contents determined based on the first media content. Based on presenting the second set of media contents, the media content presented on the detail interface may be enriched as a supplement to the first set of media contents, and the association between the presented media content and the first media content may be ensured.

In some embodiments of the present disclosure, the process 300 further includes: presenting a second playing interface of an information stream in response to a trigger for a second media content of the first set of media contents or the second set of media contents, to play the second media content, wherein the information stream includes the first set of media contents and/or the second set of media contents.

As an example, referring to FIGS. 2B and 2C, in response to trigger of any of the first set of media contents 230 or the second set of media contents 240, the electronic device 110 may present the playing interface 200C illustrated in FIG. 2C, wherein the playing interface 200C is a second playing interface of the information stream to play the second media content triggered in FIG. 2B, that is, the media content 202 illustrated in FIG. 2C.

For example, an information stream corresponding to the playing interface 200C may include at least one of the first set of media contents 203 and the second set of media contents 240.

In this way, for the trigger of any media content of the first set of media contents and the second set of media contents, the second playing interface may be entered for playing, the playing effect of the media content is improved, and the user experience is improved.

In some embodiments of the present disclosure, the process 300 further includes: switching, in response to a switching operation received on the second playing interface, the second playing interface from playing the second media content to playing a third media content in the information stream.

For example, the switching operation may be a sliding operation or a touch operation, or may be an operation of a further predetermined trigger rule, which is not limited herein.

For example, the switching operation may be a sliding operation in either direction up, down, left, or right.

The media content played on the second playing interface may be switched based on the switching operation received on the second playing interface. For example, the second media content being played by the second playing interface is switched to the third media content in the information stream. The third media content may be media content adjacent to the second media content in the information stream, for example, the previous media content or the next media content of the second media content.

In some embodiments, after switching the media content once based on the switching operation, a switching operation is received again, and the third media content being played may be switched to a further media content of the second media content or information stream based on the switching direction indicated by the switching operation.

In some embodiments, the third media content may belong to the first set of media contents or the second set of media contents as the second media content, or may belong to different set of media contents.

In this solution, the played media content is switched based on the switching operation on the second playing interface, the playing switching efficiency of the media content may be improved, and the user experience is improved.

In some embodiments of the present disclosure, the information stream includes a first set of media contents and a second set of media content, and the second media content and the third media content correspond to different sets of the first set of media contents and the second set of media contents, respectively.

In some implementations, the first set of media contents 230 and the second set of media contents 240 as illustrated in FIG. 2B are presented in different areas, respectively. In this case, for the playing sequence of the first set of media contents 230 and the second set of media contents 240 on the second playing interface 200C, the playing sequence of the first set of media contents 230 and the second set of media contents 240 on the second playing interface 200C may be related to the area presentation location, and the playing may be sequentially switched; or alternatively, the playing may be alternatively switched.

Taking the presentation sequence being played as an example, the playing sequence thereof may be: the first media content of the first set of media contents 230, the last media content of the first set of media contents 230, the first media content of the second set of media contents 240,···, the last media content of the second set of media contents 240· The playing sequence may be switched and played in a positive or reverse sequence as described above. For example, the second media content may be the last media content sequentially arranged in the first set of media contents, the third media content may be the first media content sequentially arranged in the second media content, and the playing and switching of the first set of media contents and the second set of media contents may be implemented by switching the second media content and the third media content.

For example, the playing sequence may be: the media content of the first set of media contents 230 and the media content of the second set of media contents 240 are at least partially staggered one by one or at least one staggered arrangement. During the switching operation, the second media content and the third media content before and after the switching may also belong to different groups in the first set of media contents and the second set of media contents, respectively.

In this solution, in the switching operation on the second playing interface, not only may the media content in the set of the first set of media contents or the second set of media contents be switched, but also the set switching may be performed between the first set of media contents and the second set of media contents, so that the playing switching efficiency of the media content is further improved, and the user experience is improved.

In some embodiments of the present disclosure, the second playing interface includes a first entry, and the process 300 further includes: presenting a first editing interface in response to the first entry being triggered; and generating, via the first editing interface, a first additional media content based on a content associated with a media content played by the second playing interface.

As an example, the second playing interface may refer to the playing interface 200C illustrated in FIG. 2C, the first entry may refer to the first editing entry 250 in the playing interface 200C, and the first editing interface may refer to the editing interface 200D illustrated in FIG. 2D.

Referring to FIGS. 2C and 2D, the electronic device 110 may present the editing interface 200D based on the first editing entry 250 in the trigger playing interface 200C. In this editing interface 200D, the first additional media content may be generated based on the content associated with the media content 202 played in the playing interface 200C.

For example, the content associated with the media content 202 may include, but is not limited to any of: a music content associated with the media content 202, a text content, a template, an effect, and the like.

According to the scheme, based on the first entry on the second playing interface, the first editing interface may be quickly presented to perform work conversion on the content associated with the media content played by the second playing interface, so that the work conversion rate and the work conversion efficiency of the media content are improved, the operation convenience and the operation efficiency of the user are improved, and the user experience is improved.

In some embodiments of the present disclosure, the detail interface includes a second entry, and the process 300 further includes: presenting a second editing interface in response to the second entry being triggered; and generating, via the second editing interface, a second additional media content based on the music content.

As an example, the detail interface may refer to the detail interface 200B illustrated in FIG. 2B, the second entry may refer to the second edit entry 270 on the detail interface 200B, and the second edit interface may also refer to the edit interface 200D illustrated in FIG. 2D.

It would be appreciated that both the second editing interface and the first editing interface in this solution may refer to FIG. 2D, which represents only a certain similarity between the second editing interface and the interface content in the first editing interface, does not represent that the second editing interface and the first editing interface are the same interface or an alternative interface, nor represents that the configuration information of the second editing interface and the first editing interface is necessarily the same.

Referring collectively to FIGS. 2B and 2D, based on the trigger of the second editing entry 270 on the detail interface 200B, the electronic device 110 may present the editing interface 200D. The editing interface 200D is an editing interface for generating media content based on the music content on the detail interface 200B, and the editing interface 200D may edit the music content on the detail interface 200B (the music content described by the detail panel 220) to generate the second additional media content.

In the scheme, based on the second entry on the detail interface of the music content being triggered, the second editing interface may be quickly presented to perform work conversion on the music content, so that the work conversion rate and the work conversion efficiency of the music content are improved, the operation convenience and the operation efficiency of the user are improved, and the user experience is improved.

In some embodiments of the present disclosure, the process 300 further includes: playing, in response to a fourth media content of the first set of media contents or the second set of media contents satisfying a trigger condition, the fourth media content on the detail interface; and ceasing presenting the second entry on the detail interface.

In this solution, on the detail interface of the music content, as long as the predetermined trigger condition is satisfied, the media content of the first set of media contents or the second set of media contents may be automatically played, and in the process of playing the media content, the second entry is hidden on the detail interface.

In some embodiments of the present disclosure, the trigger condition is associated with a display position of the fourth media content on the detail interface.

As an example, the fourth media content may be any media content of the first set of media contents 230 illustrated in FIG. 2B, or may be any media content of the second set of media contents 240.

In some embodiments, the display position of the media content is changed based on the sliding operation or other operation on the detail interface, as long as any fourth media content satisfies the trigger condition in the process of changing the display position, the fourth media content may be played; and in the process of playing the fourth media content, the second editing entry 270 on the detail interface 200B is hidden.

As an example, referring to FIG. 2B, on the detail interface 200B, the first set of media contents 230 presented in three columns is used as an example, for each column of media content, a corresponding trigger line may be predetermined in the display page of the interface, and when the media content of the first set of media contents 230 is triggered to trigger the corresponding trigger line based on an operation manner such as a sliding operation, the media content is played on the detail interface 200B. Herein, the trigger lines corresponding to every two columns of media content are not in the same height position on the display page, so as to avoid the situation that different media contents in the two columns trigger the corresponding trigger lines at the same time, ensure that only one trigger line is triggered at the same moment, that is, only one media content is played at the same moment, thereby ensuring the user experience.

As an example, referring to FIGS. 2B, 2E, and 5F, the second set of media contents 240 presented in two columns is taken as an example, in the display page of the detail interface 200B, two columns of media contents corresponding to the second set of media contents 240 are respectively provided with a first trigger line L1 on the left side and a second trigger line L2 located on the right side, and the positions of the first trigger line L1 and the second trigger line L2 in the page height direction of the display page are different. In this way, the situation that different media contents in two columns simultaneously trigger corresponding trigger lines may be avoided, so that only one trigger line is triggered at the same moment, that is, only one media content is played at the same moment, and the user experience is ensured.

In some embodiments, when playing on the detail interface of the music content, it may default to a silent play mode, or may default to a play mode carrying the sound, and a specific configuration condition may be selectively configured by the developer or the user, which is not limited herein.

In this solution, based on the change of the display position of the first set of media contents and the second set of media contents on the detail interface, any fourth media content is played after the trigger condition is satisfied, so that the user may view the specific content of the media content at any time during the playback process; and the second entry is hidden in the process of playing the fourth media content, so that the second entrance may be effectively prevented from blocking the fourth media content in the playback, the presentation effect of the fourth media content is ensured, and the user experience is improved.

In some embodiments of the present disclosure, resenting the second set of media contents on the detail interface includes: presenting, on the detail interface, the first set of media contents and the second set of media contents in an aggregated style; or presenting, on the detail interface, the first set of media contents and the second set of media contents respectively in different areas.

In this solution, the first set of media contents may be presented in the same area of the detail interface in an aggregation style with the second set of media contents, or may be presented in different areas of the detail interface, respectively.

As an example, the first set of media contents and the second set of media contents are presented in an aggregation style, the first set of media contents and the second set of media contents may be presented sequentially in the same area of the detail interface, or each media content of the first set of media contents and each media content of the second set of media contents may be interleaved or mixed into one media content collection, and presented one by one in the same area of the detail interface.

In this way, the first set of media contents may be supplemented with the second set of media contents, the media content presented on the detail interface and the quantity of the presented media content may be fully enriched, and the content richness presented by the detail interface may be improved.

As an example, referring also to the detail interface 200B illustrated in FIG. 2B, the first set of media contents 230 and the second set of media contents 240 are respectively presented in different areas of the detail interface 200B.

For example, the arrangement manners of the second set of media contents and the first set of media contents may be the same or different. In the scenario illustrated in FIG. 2B, the first set of media contents 230 is in a three-column fixed waterfall stream distribution, and the second set of media contents 240 is in two columns of fixed waterfall stream distribution.

In some embodiments, on the detail interface 200B, a predetermined interval may be set between the presentation areas of the first set of media contents 230 and the second set of media contents 240. By way of example, the predetermined interval may be a fixed value, or a value determined based on a predetermined calculation rule. For example, the predetermined interval may be associated with a cover height of one media content of the first set of media contents 230. For a further example, this predetermined interval may also be associated with the distance between the rendering boundary of the first set of media contents 230 and the display boundary of the detail interface 200B.

In this way, the presentation area for the first set of media contents and the second set of media contents is clearly distinguished within the detail interface, so that the user may clearly distinguish the first set of media contents and the second set of media contents, and the user experience is improved.

In some embodiments of the present disclosure, presenting the second set of media contents on the detail interface includes: presenting a set of media covers corresponding to the second set of media contents; and presenting description information in at least one media cover corresponding to at least one media content of the second set of media contents, the description information indicating interaction information of the at least one media content.

As an example, referring to the detail interface 200E illustrated in FIG. 2E, for each media content of the second set of media contents 240, the corresponding media cover 245 is presented on the detail interface 200E, and description information 245-1 of the media content is presented in the media cover 245.

In some embodiments, the description information 245-1 may be configured to indicate interaction information of the media content, for example, reference information such as an amount of edit creation of the media content, an amount of play of the media content, a quantity of likes, an amount of collection, an amount of comment, and the like; may be configured to indicate a source of the media content, for example, a collection list of the current user, and the like; or may include but is not limited to at least one of the following: an author avatar of the media content, an author name, a name of the media content, and the like.

In this solution, based on the description information in the media cover, the interaction information corresponding to the media content may be intuitively and explicitly presented.

In some embodiments of the present disclosure, the description information includes a target graphical element determined from a set of predetermined graphical elements based on the interaction information.

As an example, referring to FIG. 2E, the description information 245-1 may further include a graphic element 245-2, for example, a graphic element that represents an increase in any interaction amount such as an amount of play, an amount of attention, an amount of comment, an amount of collection, and an amount of edit. For example, the graphic element 245-2 may be obtained from a predetermined image element set.

In this solution, based on the image element, partial interaction information of the media content may be graphically presented, thereby improving salience of the part of the interaction information.

In some embodiments of the present disclosure, the second set of media contents are determined based on at least one of: first reference information associated with the first media content; second reference information associated with the music content; third reference information associated with a current user.

In some implementations, the first reference information associated with the first media content may include, but is not limited to, at least one of: a text content of the first media content, an effect, a template, an author, and the like.

The second reference information associated with the music content may include, but is not limited to, at least one of: a work style of the music content, an author, an album, and the like.

The third reference information associated with the current user may include, but is not limited to, at least one of: historical interaction information such as a historical collection record of the current user, historical comment records, historical like records, and interaction rate information such as a collection rate of media content related to the historical interaction information.

In some implementations, the second set of media contents may also be determined based on fourth reference information for the media content. For example, the fourth reference information of the media content may include, but is not limited to, at least one of: text content information of the selected media content, interaction information such as like or comments or viewing, a quantity of works that reference the media content for editing and creation, and the like.

In this way, the determining manner and the determining basis of the second set of media contents may be fully expanded, so that the relevance between the second set of media contents and the media content played on the first playing interface and the current user may be ensured, and the richness of the media content of the second set of media contents may be improved.

In some embodiments of the present disclosure, the second set of media contents are determined based on at least one of: determining a plurality of candidate media contents from a candidate media content collection; and determining the second set of media contents from the plurality of candidate media contents based on historical interaction information of the plurality of candidate media contents.

In some implementations, the candidate media content collection may include at least one of the following: a media content collection of an application platform to which the application 120 belongs, a media content collection determined based on historical interaction records of the current user of the application 120 in the current application platform, and a media content collection determined based on historical interaction records of the current user of the application 120 in the association platform.

As an example, a process of determining a plurality of candidate media content collections from the candidate media content collection is a preliminary filtering process of media content in the candidate media content collection. In this process, the media content that does not satisfy a recommendation condition in the candidate media content collection may be filtered based on a predetermined filtering condition.

For example, the predetermined filtering condition may include, but is not limited to, that the candidate media content relates to a music propaganda activity, that the candidate media content is unrecommended based on reasons such as network ecological problems or configurations only visible themselves, and the like, and the candidate media content relates to content such as camouflage or voluntary.

In this way, the media content that does not satisfy the recommendation rule may be quickly filtered out, thereby improving the determination efficiency and the presentation efficiency of the second set of media contents.

As an example, determining the second set of media contents from the plurality of candidate media contents based on the historical interaction information in the plurality of candidate media contents may include, but is not limited to, at least one of: based on a historical play amount, a historical play amount growth rate, a historical collection amount, a historical comment amount, a historical click amount, a historical work conversion rate, and the like in the candidate media content.

In this solution, a media content that does not satisfy a recommendation rule may be quickly filtered out from a candidate media content collection based on a predetermined filtering condition, to obtain a plurality of candidate media contents; and then a second set of media contents is quickly determined from the plurality of candidate media contents based on the historical interaction information of the media content. In this way, the efficiency of determining the second set of media contents can be effectively improved.

### Example Apparatus and D evice

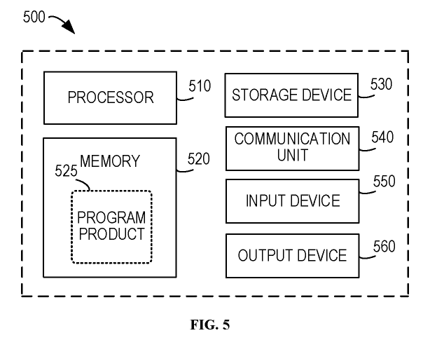

Embodiments of the present disclosure also provide a corresponding apparatus for implementing the above methods or processes. FIG. 4 illustrates a schematic structural block diagram of an example apparatus 400 for information presentation according to some embodiments of the present disclosure. The apparatus 400 may be implemented or included in the electronic device 110. The various modules/components in the apparatus 400 may be implemented by hardware, software, firmware, or any combination thereof.

As illustrated in FIG. 4, the apparatus 400 includes: a first playing module 410, a first presenting module 420, and a second presenting module 430, where the first playing module 410 is configured to present a first playing interface of a first media content, the first media content being associated with a music content; the first presenting module 420 is configured to present a detail interface of the music content in response to receiving a first operation on the first playing interface, the detail interface presenting a first set of media contents associated with the music content; and the second presenting module 430 is configured to present a second set of media contents on the detail interface in response to a quantity of media contents in the first set of media contents being less than or equal to a preset quantity, wherein at least part of the second set of media contents is determined based on the first media content.

In some embodiments of the present disclosure, the apparatus 400 further includes a second playing module configured to present a second playing interface of an information stream in response to a trigger for a second media content of the first set of media contents or the second set of media contents, to play the second media content, wherein the information stream includes the first set of media contents and/or the second set of media contents.

In some embodiments of the present disclosure, the apparatus 400 further includes a content switching module configured to switch, in response to a switching operation received on the second playing interface, the second playing interface from playing the second media content to playing a third media content in the information stream.

In some embodiments of the present disclosure, the information stream includes the first set of media contents and the second set of media contents, and the second media content and the third media content correspond to different sets of the first set of media contents and the second set of media contents respectively.

In some embodiments of the present disclosure, the second playing interface includes a first entry, and the apparatus 400 further includes a third presenting module and a first generating module, wherein the third presenting module is configured to present a first editing interface in response to the first entry being triggered; and the first generating module is configured to generate, via the first editing interface, a first additional media content based on a content associated with a media content played by the second playing interface.

In some embodiments of the present disclosure, the detail interface includes a second entry, and the apparatus 400 further includes: a fourth presenting module and a second generating module, where the fourth presenting module is configured to presente a second editing interface in response to the second entry being triggered; and the second generating module is configured to generate, via the second editing interface, a second additional media content based on the music content.

In some embodiments of the present disclosure, the apparatus 400 further includes a third playing module and a fifth presenting module, wherein the third playing module is configured to play, in response to a fourth media content of the first set of media contents or the second set of media contents satisfying a trigger condition, the fourth media content on the detail interface; and cease presenting the second entry on the detail interface

In some embodiments of the present disclosure, the trigger condition is associated with a display position of the fourth media content on the detail interface.

In some embodiments of the present disclosure, the second presenting module is further configured to: present, on the detail interface, the first set of media contents and the second set of media contents in an aggregated style; or, present, on the detail interface, the first set of media contents and the second set of media contents respectively in different areas.

In some embodiments of the present disclosure, the second presenting module is configured to present a set of media covers corresponding to the second set of media contents; and present description information in at least one media cover corresponding to at least one media content of the second set of media contents, the description information indicating interaction information of the at least one media content.

In some embodiments of the present disclosure, the description information includes a target graphical element determined from a set of predetermined graphical elements based on the interaction information.

In some embodiments of the present disclosure, the second set of media contents is determined based on at least one of: first reference information associated with the first media content; second reference information associated with the music content; third reference information associated with the current user.

In some embodiments of the present disclosure, the second set of media contents are determined based on at least one of: first reference information associated with the first media content; second reference information associated with the music content; third reference information associated with a current user.

In the apparatus 400 provided in the embodiments of the present disclosure, the specific processing process of each module and the technical effects brought by the modules may refer to the related description of the foregoing example process 300, and details are not described herein again.

As illustrated in FIG. 5, the electronic device 500 is in a form of a general-purpose electronic device. Components of the electronic device 500 may include, but are not limited to, one or more processors or processing units 510, memory 520, storage device 530, one or more communication units 540, one or more input devices 550, and one or more output devices 560.The processor 510 may be an actual or virtual processor and is capable of performing various processes based on programs stored in the memory 520. In a multiprocessor system, a plurality of processors performs computer-executable instructions in parallel to improve the parallel processing capability of the electronic device 500.

The electronic device 500 typically includes a plurality of computer storage media. Such media may be any available media accessible to the electronic device 500, including, but not limited to, volatile and non-volatile media, removable and non-removable media. The memory 520 may be volatile memory (e.g., register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, a disk, or any other medium that may be capable of storing information and/or data and may be accessible within the electronic device 500.

The electronic device 500 may further include additional removable/non-removable, volatile/non-volatile storage media. Although not illustrated in FIG. 6, a disk drive for reading from or writing to a removable, non-volatile disk (e.g., a ‘floppy disk’) and an optical disk drive for reading from or writing to a removable, non-volatile optical disk may be provided. In these embodiments, each drive may be connected to a bus (not illustrated) by one or more data media interfaces. The memory 520 may include a computer program product 525 having one or more program modules that are configured to perform various methods or actions of various embodiments of the present disclosure.

The communication unit 540 implements communication with other electronic devices via a communication medium. Additionally, the functions of the components of the electronic device 500 may be implemented as a single computing cluster or a plurality of computing machines that are capable of communicating over a communication connection. Thus, the electronic device 500 may use logical connections to one or more other servers, networked personal computers (PCs), or a further network node to operate in a networked environment.

The input device 550 may be one or more input devices, such as a mouse, a keyboard, a tracking ball, and the like. The output device 560 may be one or more output devices, such as a monitor, a speaker, a printer, and the like. The electronic device 500 may also communicate, as desired, via the communication unit 540, with one or more external devices (not illustrated), external devices such as storage devices, display devices, etc., with one or more devices that enable a user to interact with the electronic device 500, or with any device that enables the electronic device 500 to communicate with one or more other electronic devices (e.g., a network card, modem, etc.) to communicate. Such communication may be performed via an input/output (I/O) interface (not illustrated).

According to an example implementation of the present disclosure, there is provided a computer-readable storage medium having computer-executable instructions stored thereon, wherein the computer-executable instructions are performed by a processor to implement the method described above. According to an example implementation of the present disclosure, there is also provided a computer program product, the computer program product being tangibly stored on a non-transient computer-readable medium and including computer-executable instructions, wherein the computer-executable instructions are performed by a processor to implement the methods described above.

Aspects of the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that causes the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, function, and operation of possible implementations of systems, methods, and computer program products according to various implementations of the present disclosure. In this regard, each block in the flowchart or block diagram may represent a module, program segment, or part of an instruction that includes one or more executable instructions for implementing the specified logical function. In some alternative implementations, the functions noted in the blocks may also occur in a different sequence than noted in the figures. For example, two consecutive blocks may actually be performed substantially in parallel, which may sometimes be performed in the reverse sequence, depending on the function involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations would be apparent to those of ordinary skill in the art without departing from the scope and spirit of the various implementations illustrated. The determination of the terms used herein is intended to best explain the principles of the implementations, practical applications, or improvements to techniques in the marketplace, or to enable others of ordinary skill in the art to understand the various implementations disclosed herein.

What is claimed is:

1. A method for information presentation, comprising:
presenting a first playing interface of a first media content, the first media content being associated with a music content;
presenting a detail interface of the music content in response to receiving a first operation on the first playing interface, the detail interface presenting a first set of media contents associated with the music content; and
presenting a second set of media contents on the detail interface in response to a quantity of media contents in the first set of media contents being less than or equal to a preset quantity, wherein at least part of the second set of media contents is determined based on the first media content.

2. The method of claim 1, further comprising:
presenting a second playing interface of an information stream in response to a trigger for a second media content of the first set of media contents or the second set of media contents, to play the second media content, wherein the information stream comprises the first set of media contents and/or the second set of media contents.

3. The method of claim 2, further comprising:
switching, in response to a switching operation received on the second playing interface, the second playing interface from playing the second media content to playing a third media content in the information stream.

4. The method of claim 3, wherein the information stream comprises the first set of media contents and the second set of media contents, and the second media content and the third media content correspond to different sets of the first set of media contents and the second set of media contents respectively.

5. The method of claim 2, wherein the second playing interface comprises a first entry, and the method further comprises:
presenting a first editing interface in response to the first entry being triggered; and
generating, via the first editing interface, a first additional media content based on a content associated with a media content played by the second playing interface.

6. The method of claim 1, wherein the detail interface comprises a second entry, and the method further comprises:
presenting a second editing interface in response to the second entry being triggered; and
generating, via the second editing interface, a second additional media content based on the music content.

7. The method of claim 6, further comprising:
playing, in response to a fourth media content of the first set of media contents or the second set of media contents satisfying a trigger condition, the fourth media content on the detail interface; and
ceasing presenting the second entry on the detail interface.

8. The method of claim 7, wherein the trigger condition is associated with a display position of the fourth media content on the detail interface.

9. The method of claim 1, wherein presenting the second set of media contents on the detail interface comprises:
presenting, on the detail interface, the first set of media contents and the second set of media contents in an aggregated style; or
presenting, on the detail interface, the first set of media contents and the second set of media contents respectively in different areas.

10. The method of claim 1, wherein presenting the second set of media contents on the detail interface comprises:
presenting a set of media covers corresponding to the second set of media contents; and
presenting description information in at least one media cover corresponding to at least one media content of the second set of media contents, the description information indicating interaction information of the at least one media content.

11. The method of claim 10, wherein the description information comprises a target graphical element determined from a set of predetermined graphical elements based on the interaction information.

12. The method of claim 1, wherein the second set of media contents are determined based on at least one of:
first reference information associated with the first media content;
second reference information associated with the music content;
third reference information associated with a current user.

13. The method of claim 1, wherein the second set of media contents are determined based on at least one of:
determining a plurality of candidate media contents from a candidate media content collection; and
determining the second set of media contents from the plurality of candidate media contents based on historical interaction information of the plurality of candidate media contents.

14. An electronic device, comprising:
at least one processor; and
at least one memory coupled to the at least one processor and storing instructions for execution by the at least one processor, the instructions, when executed by the at least one processor, causing the electronic device to perform acts comprising:
presenting a first playing interface of a first media content, the first media content being associated with a music content;
presenting a detail interface of the music content in response to receiving a first operation on the first playing interface, the detail interface presenting a first set of media contents associated with the music content; and
presenting a second set of media contents on the detail interface in response to a quantity of media contents in the first set of media contents being less than or equal to a preset quantity, wherein at least part of the second set of media contents is determined based on the first media content.

15. The electronic device of claim 14, wherein the acts further comprise:
presenting a second playing interface of an information stream in response to a trigger for a second media content of the first set of media contents or the second set of media contents, to play the second media content, wherein the information stream comprises the first set of media contents and/or the second set of media contents.

16. The electronic device of claim 15, wherein the acts further comprise:
switching, in response to a switching operation received on the second playing interface, the second playing interface from playing the second media content to playing a third media content in the information stream.

17. The electronic device of claim 16, wherein the information stream comprises the first set of media contents and the second set of media contents, and the second media content and the third media content correspond to different sets of the first set of media contents and the second set of media contents respectively.

18. The The electronic device of claim 15, wherein the second playing interface comprises a first entry, and the acts further comprise:
presenting a first editing interface in response to the first entry being triggered; and
generating, via the first editing interface, a first additional media content based on a content associated with a media content played by the second playing interface.

19. The electronic device of claim 14, wherein the detail interface comprises a second entry, and the acts further comprise:
presenting a second editing interface in response to the second entry being triggered; and
generating, via the second editing interface, a second additional media content based on the music content.

20. A non-transitory computer-readable storage medium having a computer program stored thereon, the computer program being executable by a processor to perform acts comprising:
presenting a first playing interface of a first media content, the first media content being associated with a music content;
presenting a detail interface of the music content in response to receiving a first operation on the first playing interface, the detail interface presenting a first set of media contents associated with the music content; and
presenting a second set of media contents on the detail interface in response to a quantity of media contents in the first set of media contents being less than or equal to a preset quantity, wherein at least part of the second set of media contents is determined based on the first media content.
